(19) United States
(12) Patent Application Publication
(10) Pub. No.: US 2026/0352625 A1
(43) Pub. Date: Nov. 5, 2026

(54) COMPUTING-AWARE SERVICE ADDRESSING AND ROUTING

(71) Applicant: Nokia Solutions and Networks Oy, Espoo (FI)

(72) Inventors: Gang LIU, Shanghai (CN); Markus Sakari ISOMÄKI, Espoo (FI)

(21) Appl. No.: 19/488,157

(22) PCT Filed: May 30, 2023
(86) PCT No.: PCT/CN2023/097266

§ 371 Date: Nov. 26, 2025

(51) Int. Cl. H04L 61/4511; H04L 61/4541

(52) U.S. Cl. CPC H04L 61/4511; H04L 61/4541

(57) ABSTRACT

Embodiments of the present disclosure relate to computing-aware service addressing and routing. In an aspect, a first network device receives, from a second network device, a message associated with a domain name system (DNS) query from a terminal device. The DNS query requests a service available from a group of computing service instances. Then the first network device obtains at least one type of compute metric of the group of computing service instances. Based on the at least one type of compute metric, the first network device performs selection of a computing service instance from the group of computing service instances for the DNS query from the terminal device. As such, the network is capable of selecting the appropriate computing service instance at the granularity of each terminal device request. Thereby the communication efficiency is improved.

### FIELD

Embodiments of the present disclosure generally relate to the field of communication, and in particular, to network devices, methods, apparatuses and a computer readable storage medium for computing-aware service addressing and routing.

### BACKGROUND

With the development of 5G network, new services such as augmented reality (AR), virtual reality (VR), cloud gaming, Metaverse, vehicle to everything (V2X), remote healthcare, industrial internet, etc. have high requirements on both computing and network resources. For the network resources, these scenarios require especially high bandwidth and low latency. For the computing resources guaranteed real-time performance is expected in some cases requiring even specific type of hardware such as graphics processing units (GPUs). To meet the latency requirements, the computing needs to happen either locally or at the edge of the network.

These new services therefore act as the catalysts for integration of network and computing (INC) or compute and network convergence (CNC) concepts which aim at joint optimization of network and computation resources while meeting the applications' requirements for both. However, there is a need to improve optimization of network and computation resources.

### SUMMARY

In general, example embodiments of the present disclosure provide a solution for computing-aware service addressing and routing.

In a first aspect, there is provided a first network device. The first network device comprises at least one processor and at least one memory storing instructions that, when executed by the at least one processor, cause the first network device at least to: receive, from a second network device, a message associated with a domain name system (DNS) query from a terminal device, wherein the DNS query requests a service available from a group of computing service instances; obtain at least one type of compute metric of the group of computing service instances; and perform, based on the at least one type of compute metric, selection of a computing service instance from the group of computing service instances for the DNS query from the terminal device.

In a second aspect, there is provided a second network device. The second network device comprises at least one processor and at least one memory storing instructions that, when executed by the at least one processor, cause the second network device at least to: based on receiving a domain name system (DNS) query from a terminal device, transmit a first message indicative of the DNS query to a first network device; receive a second message indicating to forward the DNS query to a local DNS server or a central DNS server from the first network device; and transmit the DNS query to the local DNS server or the central DNS server based on the second message.

In a third aspect, there is provided a second network device. The second network device comprises at least one processor and at least one memory storing instructions that, when executed by the at least one processor, cause the second network device at least to: based on receiving a first domain name system (DNS) query from a terminal device, transmit a first message indicative of the first DNS query to a first network device; receive, from the first network device, a second message indicating to add a subnet option value into the first DNS query to obtain a second DNS query, wherein the subnet option value is indicative of network access information or a location of the terminal device; and transmit the second DNS query to a DNS server.

In a fourth aspect, there is provided a domain name system (DNS) server. The DNS server comprises at least one processor and at least one memory storing instructions that, when executed by the at least one processor, cause the DNS server at least to: receive a DNS query including a subnet option value indicative of network access information or a location of a terminal device from an edge application server discovery function (EASDF) ; determine an anycast address or a multicast address associated with a service requested by the terminal device based on the subnet option value; and transmit the anycast address or the multicast address to the EASDF.

In a fifth aspect, there is provided a method. The method comprises receiving, at a first network device from a second network device, a message associated with a domain name system (DNS) query from a terminal device, wherein the DNS query requests a service available from a group of computing service instances; obtaining at least one type of compute metric of the group of computing service instances; and performing, based on the at least one type of compute metric, selection of a computing service instance from the group of computing service instances for the DNS query from the terminal device.

In a sixth aspect, there is provided a method. The method comprises based on receiving a domain name system (DNS) query from a terminal device, transmitting, at a second network device, a first message indicative of the DNS query to a first network device; receiving, from the first network device, a second message indicating to forward the DNS query to a local DNS server or a central DNS server; and transmitting, based on the second message, the DNS query to the local DNS server or the central DNS server

In a seventh aspect, there is provided a method. The method comprises based on receiving a first domain name system (DNS) query from a terminal device, transmitting, at a second network device, a first message indicative of the first DNS query to a first network device; receiving, from the first network device, a second message indicating to add a subnet option value into the first DNS query to obtain a second DNS query, wherein the subnet option value is indicative of network access information or a location of the terminal device; and transmitting the second DNS query to a DNS server.

In an eighth aspect, there is provided a method. The method comprises receiving, at a domain name system (DNS) server from an edge application server discovery function (EASDF), a DNS query including a subnet option value indicative of network access information or a location of a terminal device; determining, based on the subnet option value, an anycast address or a multicast address associated with a service requested by the terminal device; and transmitting the anycast address or the multicast address to the EASDF.

In a ninth aspect, there is provided an apparatus. The apparatus comprises means for receiving, at a first network device from a second network device, a message associated with a domain name system (DNS) query from a terminal device, wherein the DNS query requests a service available from a group of computing service instances; means for obtaining at least one type of compute metric of the group of computing service instances; and means for performing, based on the at least one type of compute metric, selection of a computing service instance from the group of computing service instances for the DNS query from the terminal device.

In a tenth aspect, there is provided an apparatus. The apparatus comprises means for based on receiving a domain name system (DNS) query from a terminal device, transmit, at a second network device to a first network device, a first message indicative of the DNS query; means for receiving a second message indicating to forward the DNS query to a local DNS server or a central DNS server from the first network device; and means for transmitting, based on the second message, the DNS query to the local DNS server or the central DNS server.

In an eleventh aspect, there is provided an apparatus. The apparatus comprises means for based on receiving a first domain name system (DNS) query from a terminal device, transmitting, a second network device to a first network device, a first message indicative of the first DNS query; means for receiving, from the first network device, a second message indicating to add a subnet option value into the first DNS query to obtain a second DNS query, wherein the subnet option value is indicative of network access information or a location of the terminal device; and means for transmitting the second DNS query to a DNS server.

In a twelfth aspect, there is provided an apparatus. The apparatus comprises means for receiving, at a domain name system (DNS) server from an edge application server discovery function (EASDF), a DNS query including a subnet option value indicative of network access information or a location of a terminal device; means for determining an anycast address or a multicast address associated with a service requested by the terminal device based on the subnet option value; and means for transmitting the anycast address or the multicast address to the EASDF.

In a thirteenth aspect, there is provided a non-transitory computer readable medium comprising program instructions for causing an apparatus to perform at least the method according to any one of the above fifth to eighth aspect.

In a fourteenth aspect, there is provided a computer program comprising instructions, which, when executed by an apparatus, cause the apparatus at least to: receive, from a second network device, a message associated with a domain name system (DNS) query from a terminal device, wherein the DNS query requests a service available from a group of computing service instances; obtain at least one type of compute metric of the group of computing service instances; and perform, based on the at least one type of compute metric, selection of a computing service instance from the group of computing service instances for the DNS query from the terminal device.

In a fifteenth aspect, there is provided a computer program comprising instructions, which, when executed by an apparatus, cause the apparatus at least to: based on receiving a domain name system (DNS) query from a terminal device, transmit, to a first network device, a first message indicative of the DNS query; receive a second message indicating to forward the DNS query to a local DNS server or a central DNS server from the first network device; and transmit the DNS query to the local DNS server or the central DNS server based on the second message.

In a sixteenth aspect, there is provided a computer program comprising instructions, which, when executed by an apparatus, cause the apparatus at least to: based on receiving a first domain name system (DNS) query from a terminal device, transmit, to a first network device, a first message indicative of the first DNS query; receive, from the first network device, a second message indicating to add a subnet option value into the first DNS query to obtain a second DNS query, wherein the subnet option value is indicative of network access information or a location of the terminal device; and transmit the second DNS query to a DNS server.

In a seventeenth aspect, there is provided a computer program comprising instructions, which, when executed by an apparatus, cause the apparatus at least to: receive, from an edge application server discovery function (EASDF), a DNS query including a subnet option value indicative of network access information or a location of a terminal device; determine, based on the subnet option value, an anycast address or a multicast address associated with a service requested by the terminal device; and transmit the anycast address or the multicast address to the EASDF.

In an eighteenth aspect, there is provided a first network device. The first network device comprises receiving circuitry configured to receive, from a second network device, a message associated with a domain name system (DNS) query from a terminal device, wherein the DNS query requests a service available from a group of computing service instances; obtaining circuitry configured to obtain at least one type of compute metric of the group of computing service instances; and performing circuitry configured to perform selection of a computing service instance from the group of computing service instances for the DNS query from the terminal device based on the at least one type of compute metric.

In a nineteenth aspect, there is provided a second network device. The second network device comprises transmitting circuitry configured to, based on receiving a domain name system (DNS) query from a terminal device, transmit to a first network device a first message indicative of the DNS query; receiving circuitry configured to receive a second message indicating to forward the DNS query to a local DNS server or a central DNS server from the first network device; and transmitting circuitry configured to, based on the second message, transmit the DNS query to the local DNS server or the central DNS server

In a twentieth aspect, there is provided a second network device. The second network device comprises transmitting circuitry configured to, based on receiving a first domain name system (DNS) query from a terminal device, transmit, to a first network device, a first message indicative of the first DNS query; receiving circuitry configured to receive, from the first network device, a second message indicating to add a subnet option value into the first DNS query to obtain a second DNS query, wherein the subnet option value is indicative of network access information or a location of the terminal device; and transmitting circuitry configured to transmit the second DNS query to a DNS server.

In a twenty-first aspect, there is provided a domain name system (DNS) server. The DNS server comprises receiving circuitry configured to receive, from an edge application server discovery function (EASDF), a DNS query including a subnet option value indicative of network access information or a location of a terminal device; determining circuitry configured to determine, based on the subnet option value, an anycast address or a multicast address associated with a service requested by the terminal device; and transmitting circuitry configured to transmit the anycast address or the multicast address to the EASDF.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example network environment in which example embodiments of the present disclosure may be implemented;

FIG. 1B illustrates an example scenario of an edge application server (EAS) selection for a terminal device request related to some embodiments of the present disclosure;

FIG. 2 illustrates an example signaling chart illustrating an example process according to some embodiments of the present disclosure;

FIG. 3 illustrates an example signaling chart illustrating an example process according to some embodiments of the present disclosure;

FIG. 4 illustrates an example process of computing-aware service routing according to some embodiments of the present disclosure;

FIG. 5 illustrates an example process according to some embodiments of the present disclosure;

FIG. 6 illustrates another example process according to some embodiments of the present disclosure;

FIG. 7 illustrates a flowchart of a method implemented at a first network device according to some embodiments of the present disclosure;

FIG. 8 illustrates a flowchart of a method implemented at a second network device according to some embodiments of the present disclosure;

FIG. 9 illustrates a flowchart of a method implemented at a second network device according to some embodiments of the present disclosure;

FIG. 10 illustrates a flowchart of a method implemented at a DNS server according to some embodiments of the present disclosure;

FIG. 11 illustrates a simplified block diagram of an apparatus that is suitable for implementing embodiments of the present disclosure; and

FIG. 12 illustrates a block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “anycast” refers to a network addressing and routing methodology in which a single destination Internet protocol (IP) address is shared by multiple devices (generally servers) in different locations. Routers direct packets addressed to this destination IP address to the location nearest the sender, using their normal decision-making algorithms, typically the lowest number of BGP network hops. Anycast routing is widely used for specific purposes such as forwarding domain name system (DNS) queries to the closest server instance. Anycast is often deployed in a limited area as supporting it in a larger scale has challenges.

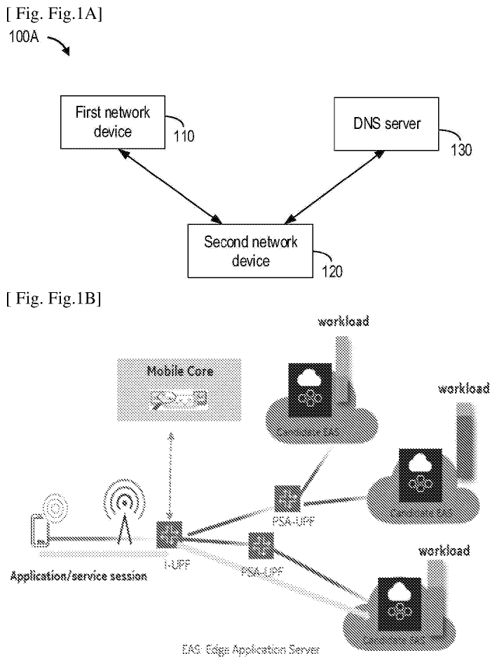

FIG. 1A illustrates an example network environment 100A in which example embodiments of the present disclosure may be implemented. The environment 100A, which may be a part of a communication network, comprises network devices.

As illustrated in FIG. 1A, the communication network 100A may comprise a first network device 110, a second network device 120, and a DNS server 130. The first network device 110 device 110 and the second network device 120 may communicate with each other, and the first network device 110 and the DNS server 130 may communicate with each other, too. In some embodiments, the first network device 110 may be a session management function (SMF) in core network. In some embodiments, the first network device 110 may be a new function such as an “integration of network and compute function (INCF)” in core network. In some embodiments, the second network device 120 may be an edge application server discovery function (EASDF).

It is to be understood that the number of network devices is only for the purpose of illustration without suggesting any limitations. The environment 100A may include any suitable number of network devices adapted for implementing embodiments of the present disclosure.

With the development of 5G network, new services such as augmented reality (AR), virtual reality (VR), cloud gaming, Metaverse, vehicle to everything (V2X), remote healthcare, industrial internet, etc. have high requirements on both computing and network resources. For the network resources, these scenarios require especially high bandwidth and low latency. For the computing resources guaranteed real-time performance is expected in some cases requiring even specific type of hardware such as graphics processing units (GPUs). To meet the latency requirements, the computing needs to happen either locally or at the edge of the network.

These new services therefore act as the catalysts for integration of network and computing (INC) or compute and network convergence (CNC) concepts which aim at joint optimization of network and computation resources while meeting the applications' requirements for both.

To support low latency service, it is assumed that a service may have several service instances running on different compute nodes or sites close to the network edge. FIG. 1B illustrates an example scenario of an EAS selection related to some embodiments of the present disclosure. As shown in FIG. 1B, multiple candidate EASs are able to offer the same service no matter where they are deployed. The multiple candidate EASs have different workloads. The problem is how to select an appropriate EAS and build optimal path for each user (UE) request while considering both network and computing metrics.

In Dyncast (dynamic anycast) mechanism, each service instance is configured with the same anycast IP address and the network will forward client host packets to the optimal instance. In the design of Dyncast solution, an anycast address is used as a unique identifier (ID) to identify a service, therefore equal to the service identifier (SID). Any service instance providing the same service will be configured with the same anycast address. When a client sends requests for specific service, the destination IP address will be set as the corresponding anycast address (i.e. SID).

The accessible unicast IP address of each service instance is defined as the binding ID (BID) which is used to identify and access a particular service instance. Each service instance will report both its BID (i.e. unicast IP address) and hosted SID (i.e. anycast IP address) to the nearby Dyncast overlay node. Then the registration/declaration of the corresponding anycast IP address (i.e. SID) will be by some means propagated among the whole overlay. The binding relationship of BID and SID as well as other network/ compute metrics will be maintained in the“ control plane” of the overlay.

In 5G system, any traffic flows can be tunneled between an intermediate user plane function (I-UPF) and a protocol data unit session anchor UPF (PSA-UPF) based on rules provided by the session management function (SMF). SMF itself can be given steering influence information by an external function including a generic application function (AF) or an EASDF. The EASDF can act as a DNS full resolver and in special cases as an authoritative DNS server for specific domains. When acting as a resolver it is in contact with the SMF to learn of an IP subnet representing the an optimal (close-by) PSA-UPF for the UE making a DNS query. The EASDF inserts this IP subnet within a DNS query as the value for the client subnet option. The authoritative DNS server responding to the query can tailor its response for an optimal EAS IP address assuming the UE is close to the topological location of that IP subnet in the Internet topology. When the DNS response includes the option, the EASDF (resolver) considers the response to contain EAS IP address(es) optimal for the designated PSA-UPF and requests the SMF to forward UE traffic to/from that EAS IP address to that PSA-UPF. With this there is a way to perform EAS selection so that an EAS close to a PSA-UPF close to the UE is selected. This method does not take compute metrics of the EAS into account or neither does it allow choosing across multiple PSA-UPFs or EAS's based on any dynamic information.

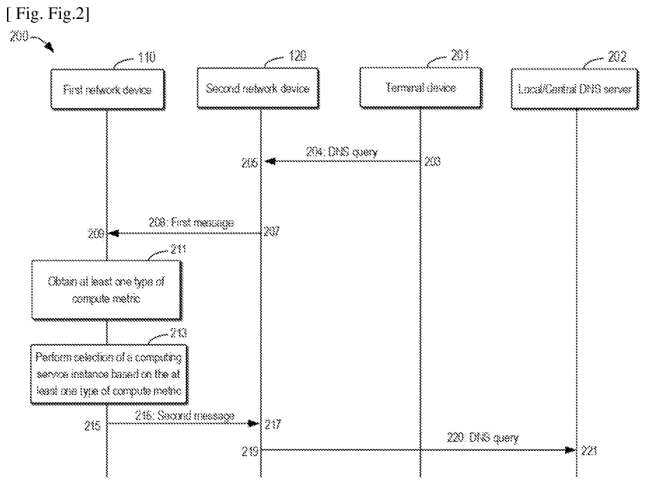

According to some embodiments of the present disclosure, a solution is provided for computing-aware service addressing and routing. In one aspect of the solution of the present disclosure, a first network device receives, from a second network device, a message associated with a domain name system (DNS) query from a terminal device. The DNS query requests a service available from a group of computing service instances. Then the first network device obtains at least one type of compute metric of the group of computing service instances. Based on the at least one type of compute metric, the first network device performs selection of a computing service instance from the group of computing service instances for the DNS query from the terminal device. As such, the network is capable of selecting the appropriate computing service instance at the granularity of each terminal device request. Thereby the communication efficiency is improved. Example embodiments of the present disclosure for data volume prediction will be described below with reference to FIGS. 2-12.

FIG. 2 illustrates an example signaling chart illustrating an example process 200 according to some embodiments of the present disclosure. For the purpose of discussion, the process 200 will be described with reference to FIG. 1A. The process 200 may involve the first network device 110, the second network device 120, the terminal device 201, and the local/central DNS server 202. It would be appreciated that although the process 200 has been described in the communication environment 100A of FIG. 1A, this process 200 may be likewise applied to other communication scenarios with similar issues.

In the process 200, a terminal device 201 transmits 203 a DNS query 204 to the second network device 120. Based on receiving 203 the DNS query 204 from a terminal device 201, the second network device 120 transmits 207 a first message 208 indicative of the DNS query to a first network device 110, and the DNS query requests a service available from a group of computing service instances. For example, the computing service instances may be edge application server (EAS) instances. An IP anycast address may be designated for a group of EAS instances offering the same service. The scope of the group and the anycast address can be the whole access network or a specific sub-area of it. In some embodiments, the DNS query may be triggered by an application in the terminal device. In some embodiments, the first network device 110 may be a session management function (SMF), access and mobility management function (AMF), policy control function (PCF) or a new function such as an “integration of network and compute function (INCF)” which operates together with the SMF.

Correspondingly, the first network device 110 receives 209 the first message 208 from the second network device 120. In some embodiments, the first message 208 may comprise a DNS request message reporting the DNS query to the first network device. In some embodiments, the first message 208 may comprise a fully qualified domain name (FQDN) indicating the service requested by the terminal device.

The first network device 110 obtains 211 at least one type of compute metric of the group of computing service instances. In some embodiments, in order to obtain the at least one type of compute metric, the first network device 110 may receive the at least one type of compute metric based on transmitting a request for the at least one type of compute metric. In some embodiments, in order to obtain the at least one type of compute metric, the first network device 110 may receive the at least one type of compute metric based on subscribing dynamic update of the at least one type of compute metric. For example, the SMF, which is already aware of the detailed metrics of the mobile (5G/6G) core network also accesses the dynamic compute metrics of the EAS's either on-demand or by subscribing to updates.

In some embodiments, the at least one type of compute metric may comprise load information of the group of computing service instances. In some embodiments, the at least one type of compute metric may be indexed by an FQDN, an anycast address corresponding to the service, or a combination of the above-mentioned two items.

Based on the at least one type of compute metric, the first network device 110 performs 213 selection of a computing service instance from the group of computing service instances for the DNS query from the terminal device.

In some embodiments, the first network device 110 may further perform selection of an egress node of a network domain, based on the at least one type of compute metric, at least one type of network metric associated with the group of computing service instance and information of egress nodes of the network domain. In some embodiments, the egress node of the network domain may be a PSA-UPF in 5G system, and the information of PSA-UPFs is known to the first network device. For example, the first network device is able to choose the optimal EAS out of the group of EAS's sharing a common anycast address and at the same time choose the optimal PSA-UPF via which the traffic to that EAS instance is forwarded. Different criteria for determining the optimal EAS instance and PSA-UPF can be used.

Then the first network device 110 transmits 215 a second message 216 to the second network device 120. The second message 216 indicates the second network device 120 to forward the DNS query to a local DNS server or a central DNS server 202.

In some embodiments, the first network device 110 may transmit the second message indicating to forward the DNS query to the local DNS server based on selecting a computing service instance from the group of computing service instances. In some embodiments, the first network device 110 may transmit the second message indicating to forward the DNS query to the central DNS server based on failing to select a computing service instance from the group of computing service instances.

For example, at the DNS query stage, the first network device 110 checks if there is a group of EAS instances available for the queried FQDN and accesses their compute metrics. If a suitable and optimal EAS instance is available, the first network device 110 instructs the second network device to forward the DNS query to a specific local authoritative DNS server which is configured to resolve the FQDN to a designated ÍP anycast address. The resolution may be made specific to terminal device's current location by first network device instructing the second network device to insert a specific Client IP Subnet option value to the query. If no suitable EAS instance is available, the first network device can instruct the second network device to forward the query according to default procedures possibly to a different non-local authoritative DNS server.

After receiving 217 the second message 216, the second network device 120 transmits 219 the DNS query 220 to the local DNS server or the central DNS server based on the second message. In some embodiments, the second network device may further receive a DNS response comprising an anycast address or a multicast address corresponding to the service requested by the DNS query from the local DNS server. Then the second network device 120 may transmit a third message to the first network device. The third message reports that a DNS response received by the second network device from the local DNS server. In some embodiments, the first network device 110 may receive the third message from the second network device, the first network device 110 may steer traffic associated with the service of the terminal device to the egress node.

For example, after choosing the optimal combination of the EAS instance and the PSA-UPF, the first network device may configure an intermediate UPF to forward terminal device traffic to the IP anycast address to the chosen PSA-UPF. The DNS response given to the DNS client includes the IP anycast address and the application starts to communicate with that IP address. The traffic forwarding setup by the SMF steers the traffic to the optimal PSA-UPF.

With the solution, the authoritative DNS server may operate based on static configuration, and the dynamic decision making happens on the network control plane. Compared to the current procedures, the optimal computing service instance selection does not have to be based on a single local PSA-UPF but any number of candidate PSA-UPFs can be considered by the network. local DNS server or the central DNS server can be dynamically chosen, means the target server instance could be outside of mobile domain if a central DNS server is chosen which is probably controlled by other third party. The solution is compatible with conventional anycast-based IP domain solution or tailored DNS-response solution. In addition, the solution is not limited to anycast addresses, any reserved unicast or multicast IP address can be used as a DNS response (i.e., destination IP) so long as the corresponding traffics can be steered within mobile network.

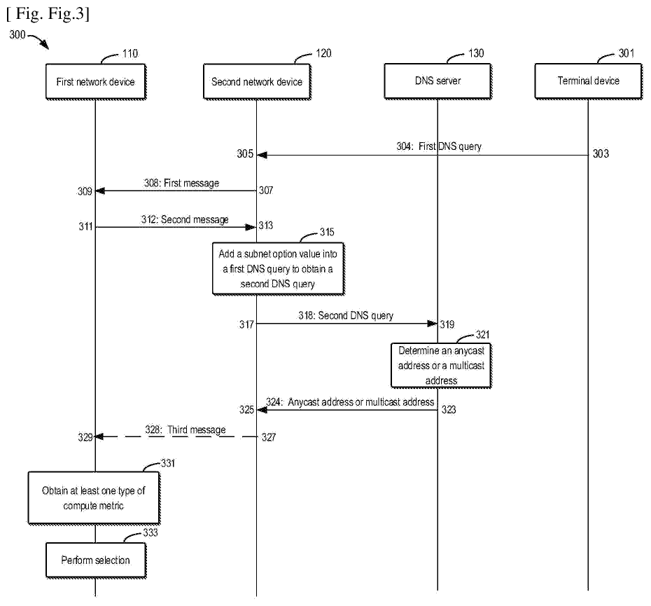

FIG. 3 illustrates an example signaling chart illustrating an example process 300 according to some embodiments of the present disclosure. For the purpose of discussion, the process 300 will be described with reference to FIG. 1A. The process 300 may involve the first network device 110, the second network device 120, the DNS server 130, and the terminal device 301. It would be appreciated that although the process 300 has been described in the communication environment 100A of FIG. 1A, this process 300 may be likewise applied to other communication scenarios with similar issues.

In the process 300, a terminal device 301 transmits 303 a first DNS query 304 to a second network device 120. Based on receiving 305 a first DNS query 304 from a terminal device 301, the second network device 120 transmits 307 a first message 308 indicative of the first DNS query to the first network device 110, and the first DNS query requests a service available from a group of computing service instances. Correspondingly, the first network device 110 receives 309 the first message 308 from the second network device 120. The first message 308 is associated with the first DNS query from the terminal device.

Then the first network device 110 transmits 311 a second message 312 to the second network device 120, and the second message 312 indicates to add a subnet option value into the first DNS query to obtain a second DNS query. The subnet option value is indicative of network access information, a location of the terminal device, a set of egress nodes available for the location of the terminal device, or any combination of two or more of the above-mentioned items. For example, at the DNS query stage, the first network device instructs the second network device to insert a terminal device location specific Client IP subnet option value to the query and forward the query to an authoritative DNS server.

The second network device 120 receives 313 the second message 312 from the first network device 110. After adding 315 a subnet option value into the first DNS query to obtain a second DNS query, the second network device 120 transmits 317 the second DNS query 318 to a DNS server 130. In some embodiments, the subnet option value may further indicative of a set of egress nodes available for the location of the terminal device.

The DNS server 130 receives 319 the second DNS query 318 from the second network device 120. Based on the subnet option value included in the second DNS query 318, the DNS server 130 determines 321 an anycast address or a multicast address associated with a service requested by the terminal device. Then the DNS server 130 transmits 323 the anycast address or the multicast address 324 to the second network device 120.

In some embodiments, after receiving 325 the anycast address or the multicast address from the DNS server 130, the second network device 120 may transmit 327 a third message 328 to the first network device, the third message 328 reports that a DNS response received by the second network device from a DNS server includes a subnet option value associated with the terminal device. In some embodiments, the DNS query may comprise a FQDN indicating the service requested by the terminal device.

After receiving 329 the DNS request, the first network device 110 obtains 331 at least one type of compute metric of the group of computing service instances. In some embodiments, in order to obtain the at least one type of compute metric, the first network device 110 may receive the at least one type of compute metric based on transmitting a request for the at least one type of compute metric. In some embodiments, in order to obtain the at least one type of compute metric, the first network device 110 may receive the at least one type of compute metric based on subscribing dynamic update of the at least one type of compute metric. For example, at the DNS response stage, if the DNS response includes the client subnet option and is resolved to an IP anycast address which has been configured with some EAS instances known to the first network device, the first network device accesses the compute metrics of the EAS instances sharing the anycast address and/or the queried FQDN.

In some embodiments, the at least one type of compute metric may comprise load information of the group of computing service instances. In some embodiments, the at least one type of compute metric may be indexed by an FQDN, an anycast address corresponding to the service, or a combination of the above-mentioned two items.

Based on the at least one type of compute metric, the first network device 110 performs 333 selection of a computing service instance from the group of computing service instances for the DNS query from the terminal device. In some embodiments, the first network device 110 may further perform selection of an egress node of a network domain, based on the at least one type of compute metric, at least one type of network metric associated with the group of computing service instance and information of egress nodes of the network domain. In some embodiments, the egress node of the network domain may be a PSA-UPF in 5G system, and the information of PSA-UPFs is known to the first network device.

In this way, the DNS server responding to the query can operate based on a relatively static configuration and does not need to know or consider dynamic network or compute metrics. In addition, the solution is not limited to anycast addresses, any reserved unicast or multicast IP address can be used as a DNS response (i.e., destination IP) so long as the corresponding traffics can be steered within mobile network.

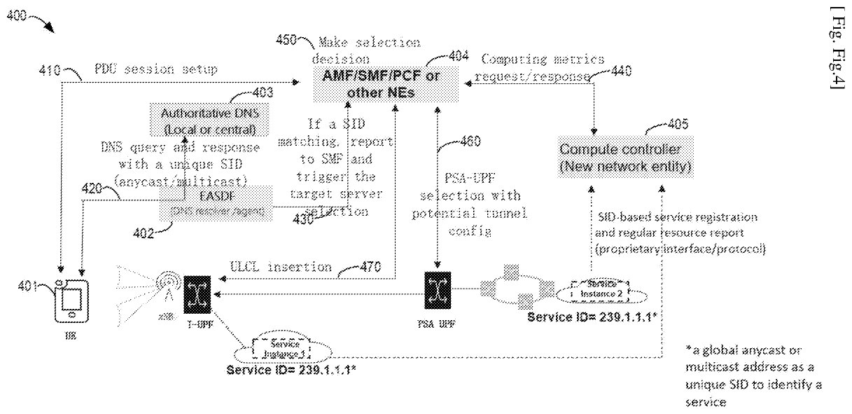

FIG. 4 illustrates an example process of computing-aware service routing according to some embodiments of the present disclosure. The process 400 may involve a UE 401, a EASDF 402, an authoritative DNS 403, a AMF/SMF/PCF or other NEs 404, and compute controller 405. The compute controller 405 is a new network entity. The service instance 1 and the service instance 2 share a same SID. The SID-based service registration messages and regular resource reports are transmitted form the service instances to the compute controller 405. It is understood that the process 400 can be considered as a more specific example of the process 200 in FIG. 2. Thus, the EASDF 402 in FIG. 4 may be an example of the second network device 120 in FIG. 1A or 2, the authoritative DNS 403 in FIG. 4 may be an example of the DNS server 130 in FIG. 1A or FIG. 2, and the AMF/SMF/PCF or other NEs 304 in FIG. 4 may be an example of the first network device 110 in FIG. 1A or FIG. 2.

In the process 400, the UE 401 sets up 410 a protocol data unit (PDU) session with the AMF/SMF/PCF or other NEs 404. Then the UE 401 transmits 420 a DNS query to the authoritative DNS 403 via the EASDF 402, the authoritative DNS server 403 transmit a DNS response with a unique SID (i.e., an anycast or multicast IP address) to the UE 401 via the EASDF 402. If the SID matching specific FQDNs pre-configured at the EASDF 402, the EASDF 402 reports 430 the DNS query to the AMF/SMF/PCF or other NEs 404 and triggers server selection. After being triggered by the EASDF 402, the AMF/SMF/PCF or other NEs 404 transmits 440 a computing metrics request for computing metrics to the compute controller 405. Then the AMF/SMF/PCF or other NEs 404 receives a computing metrics response from the compute controller 405. Based on the computing metrics, the AMF/SMF/PCF or other NEs 404 makes 450 a selection decision of the service instance. At the same time, the AMF/SMF/PCF or other NEs 404 makes 460 a PSA-UPF selection with a potential tunnel configuration.

Thereby, DNS-assisted computing-aware service addressing and routing approach enables mobile core network to select the appropriate EAS at the granularity of each UE request. This combines the current EASDF mechanism and the dynamic anycast mechanism and maps the latter to the mobile core network traffic steering mechanisms. Utilize the conventional standard 5GS EASDF operation and traffic steering for handling UE originated DNS queries used for resolving a FQDN to an IP address. The authoritative DNS server responding to the query can operate based on a relatively static configuration and does not need to know or consider dynamic network or compute metrics. UE service requests (traffic flows) is mapped to the optimal EAS instances based on dynamic network and compute metrics.

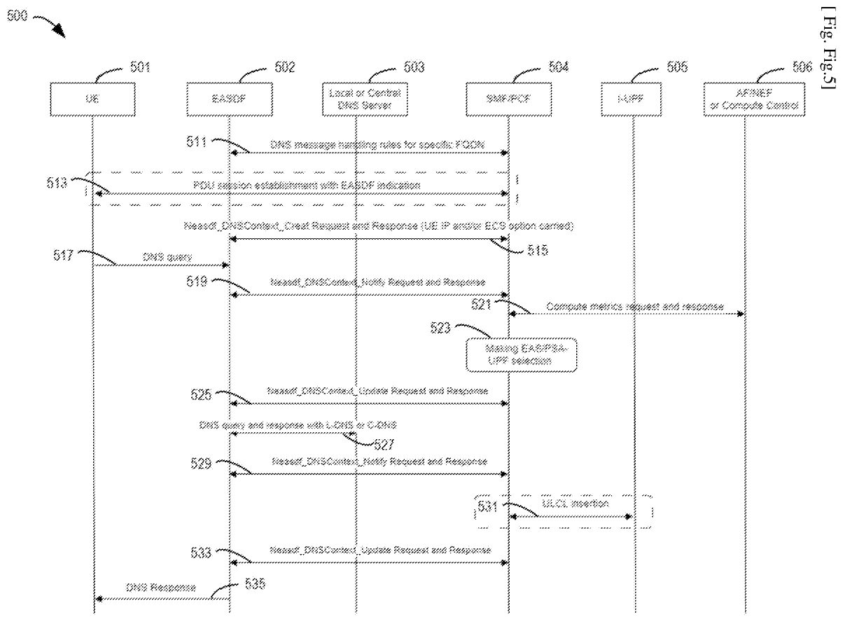

FIG. 5 illustrates an example process according to some embodiments of the present disclosure. The process 500 may involve a UE 501, a EASDF 502, a local or central DNS server 503, a SMF/PCF 504, I-UPF 505 and AF/NEF or compute control 506. It is understood that the process 500 can be considered as a more specific example of the process 300 in FIG. 3. Thus, the EASDF 502 in FIG. 5 may be an example of the second network device 120 in FIG. 1A or 3, the local or central DNS server 503 in FIG. 5 may be an example of the DNS server 130 in FIG. 1A or FIG. 3, and the SMF/PCF 504 in FIG. 5 may be an example of the first network device 110 in FIG. 1A or FIG. 3.

In process 500, at 511, SMF/PCF 504 transmits DNS message handling rules regarding to specific FQDNs to EASDF 502, which means DNS queries to those FQDNs will be handled in a special way by the EASDF. At 513, the UE 501 performs the regular PDU session establishment with the EASDF configuration instructed by the SMF/PCF 504. At 515, the SMF/PCF 504 transmits a Neasdf_DNSContext_Create request message to the EASDF 502, in order to instructs the EASDF 502 to create DNS context for UE 501 in which UE IP and potential elastic compute service (ECS) options are maintained. After receiving the Neasdf_DNSContext_Create request message, the EASDF 502 transmit a Neasdf_DNSContext_Create response message to the SMF/PCF 504.

At 517, the UE 501 sends a DNS query message to the SMF/PCF 504 triggered by an application in the UE 501, and the DNS query message is forward by the EASDF 502. If the UE 501 is a router, the DNS query may be originated from another IP host behind it.

At 519, the EASDF 502 reports to the SMF/PCF 504 the received resolving request by transmitting a Neasdf_DNSContext_Notify request message to the SMF/PCF 504.

After receiving the Neasdf_DNSContext_Notify request message from the EASDF 502, the SMF/PCF 504 transmits a Neasdf_DNSContext_Notify response message to the EASDF 502. At 521, based on target FQDN information carried in the EASDF 502's report, the SMF/PCF 504 transmits a compute metric request to the AF/NEF or compute control 506. Then the AF/NEF or compute control 506 transmits a compute metric response to the SMF/PCF 504. In other words, the SMF/PCF 504 requests and obtains the relevant computing metrics of candidate EASs from the computing resource provider. The compute metrics may be available from a metrics agent via various types of interfaces including, e.g., the application layer transport optimization (ALTO) protocol. The process may involve intermediate functions such as an AF via NEF. In some embodiments, the SMF/PCF 504 may not need to request the compute metrics on demand but may be subscribed to the relevant metrics and be aware of them based on dynamic updates.

At 523, based on the network metrics already known to the SMF/PCF 504 and compute metrics obtained in the previous step, the SMF/PCF 504 makes a EAS and PSA-UPF selection. In other words, SMF/PCF 504 makes the decision whether one of the candidate EAS's and an optimal PSA-UPF corresponding to it can be selected.

At 525, the SMF/PCF 504 transmits a Neasdf_DNSContext_Update request message to the EASDF 502, in order to informs the EASDF 502 with the updated DNS context which will contain the DNS message handing rule instructing how to forward or handle relevant DNS query, e.g., to a local-DNS server or a central DNS server.

At 527, if an appropriate EAS associated with the mobile network is selected, the SMF/PCF 504 will instruct the EASDF 502 to forward the DNS query to a local DNS server assuming the role of the authoritative DNS server for the queried domain. Otherwise, the SMF/PCF 504 will instruct the EASDF 502 to query for the authoritative DNS server for the domain according to normal DNS procedures. Based on this, a central DNS server may be selected. The SMF/PCF 504 may instruct the EASDF 502 to add a specific client IP subnet value to the query.

If the local DNS server is contacted, the local DNS server transmits a DNS response message to the EASDF 502, the reserved anycast (or multicast) IP address mapping to the requested FQDN will be sent back as the DNS response message. At 529, in order to report to the SMF/PCF 504 the received DNS query response which triggers the SMF to perform relevant traffic steering, the EASDF 502 transmits a Neasdf_DNSContext_Notify request message to the SMF/PCF 504. After receiving the Neasdf_DNSContext_Notify request message from the EASDF 502, the SMF/PCF 504 transmits a Neasdf_DNSContext_Notify response message to the EASDF 502.

At 531, according to the target EAS and PSA-UPF selected, the SMF/PCF 504 chooses the proper I-UPF and inserts uplink classifier rules which identify traffic from the UE 501 to the anycast (or multicast) address and steer it to the target PSA UPF. At 533, through the Neasdf_DNSContext_Update request message, the SMF/ PCF 504 informs the EASDF 502 to forward the DNS response to UE 501. At 535, after receiving the Neasdf_DNSContext_Update request message, the EASDF 502 transmits the DNS response to the UE 501. The EASDF 502 further transmit a Neasdf_DNSContext_Update response message to the EASDF 502. With the resolved destination IP address, the UE 501 builds-up the application or service session with the target EAS.

FIG. 6 illustrates an example process according to some embodiments of the present disclosure. The process 600 may involve a UE 601, a EASDF 602, an authoritative DNS server 603, a SMF/PCF 604, I-UPF 605 and AF/NEF or compute control 606. It is understood that the process 600 can be considered as a more specific example of the process 200 in FIG. 2. Thus, the EASDF 602 in FIG. 4 may be an example of the second network device 120 in FIG. 1A or 2, the local or central DNS server 603 in FIG. 6 may be an example of the DNS server 130 in FIG. 1A or FIG. 2, and the SMF/PCF 604 in FIG. 6 may be an example of the first network device 110 in FIG. 1A or FIG. 2.

In process 600, at 611, SMF/PCF 604 transmits DNS message handling rules regarding to specific FQDNs to EASDF 602, which means DNS queries to those FQDNs will be handled in a special way by the EASDF. At 613, the UE 601 performs the regular PDU session establishment with the EASDF configuration instructed by the SMF/PCF 604. At 615, the SMF/PCF 604 transmits a Neasdf_DNSContext_Create request message to the EASDF 602, in order to instructs the EASDF 602 to create DNS context for UE 601 in which UE IP and potential elastic compute service (ECS) options are maintained. After receiving the Neasdf_DNSContext_Create request message, the EASDF 602 transmit a Neasdf_DNSContext_Create response message to the SMF/PCF 604.

At 617, the UE 601 sends a DNS query message to the SMF/PCF 604 triggered by an application in the UE 601, and the DNS query message is forward by the EASDF 602. If the UE 501 is a router, the DNS query may be originated from another IP host behind it. At 619, the EASDF 602 reports to the SMF/PCF 604 the received resolving request by transmitting a Neasdf_DNSContext_Notify request message to the SMF/PCF 604. After receiving the Neasdf_DNSContext_Notify request message from the EASDF 602, the SMF/PCF 604 transmits a Neasdf_DNSContext_Notify response message to the EASDF 602. At 621, the SMF/PCF 604 further transmits a Neasdf_DNSContext_Update request message to the EASDF 602. With the Neasdf_DNSContext_Update request message, the SMF/PCF 604 instructs the EASDF 602 to continue DNS query processing according to the normal DNS procedures but to add a specific client IP subnet value to the DNS query. This subnet does not necessarily represent a specific single PSA-UPF but may represent a set of PSA-UPFs available for the UE 601 in its current location.

At 623, after receiving the Neasdf_DNSContext_Update request message, the EASDF 602 transmits a DNS query with a specific client IP subnet value to the authoritative DNS server 603. The authoritative DNS server 603 has been configured to resolve the FQDN to a specific IP anycast (or multicast) address based on the client IP subnet option or the resolver IP address. At 625, the authoritative DNS server 603 transmits a DNS response to the SMF/PCF 604, i.e., the authoritative DNS server 603 responds to the DNS query with this address. If no specific configuration for the FQDN or domain exists for the specific IP client subnet the DNS server follows its default logic.

At 625, based on the DNS message handling rules, the EASDF 602 reports the DNS response to the SMF/PCF 604 through a Neasdf_DNSContext_Notify request message if the DNS response included the IP client subnet option, which means that the authoritative DNS server tailored its response based on the IP client subnet option.

If the DNS response includes an IP anycast (or multicast) address known to be in use at the network edge, the SMF/PCF 604 obtains the compute metrics of the EAS's associated with that FQDN and/or the anycast address. At 627, the SMF/PCF 604 transmits a compute metric to the AF/NEF or compute control 606. Then the AF/NEF or compute control 606 transmits a compute metric response to the SMF/PCF 604.

Based on the combined network and compute metrics, the SMF 604 makes a EAS and PSA-UPF selection. In other words, SMF/PCF 604 makes the decision of the optimal EAS and PSA-UPF. According to the target EAS and PSA-UPF selected, the SMF/PCF 604 chooses the proper I-UPF and inserts 531 uplink classifier rules which identify traffic from the UE 601 to the anycast (or multicast) address and steer it to the target PSA UPF. At 633, through the Neasdf_DNSContext_Update request message, the SMF/PCF 604 informs the EASDF 602 to forward the DNS response to UE 601. At 635, after receiving the Neasdf_DNSContext_Update request message, the EASDF 602 transmits the DNS response to the UE 601. The EASDF 602 further transmit a Neasdf_DNSContext_Update response message to the EASDF 602. With the resolved destination IP address, the UE 601 builds-up the application or service session with the target EAS.

In the processes 500 and 600, the DNS query message sent by UE client is employed to trigger the service addressing and routing procedure. The EASDF is responsible for acting as a full resolver for the DNS query and handling the DNS protocol messages according to the instruction from the SMF. The actions performed by the EASDF comprise: receiving DNS message handling rules and/or baseline DNS pattern from the SMF; exchanging DNS messages from the UE; forwarding DNS messages to C-DNS or L-DNS for DNS query; adding DNS Client IP subnet value to an outgoing query based on instruction by the SMF; reporting to the SMF the information related to the received DNS messages; buffering/discarding DNS messages from the UE or DNS server.

The EAS selection is actually performed by authoritative DNS server which is able to tailor its response, e.g., depending on the location of the client as indicated either by the DNS query source IP address (EASDF or other DNS resolver) or the client IP subnet option (as inserted in this case by the EASDF). This is relatively static and coarse grained information given to the authoritative DNS server typically by configuration.

Based on it alone the DNS server does not know of the exact or dynamic network metrics between the UE client and the candidate EAS's via different potential PSA-UPFs. The authoritative DNS server may utilize also EAS compute metrics when making its decision if these are available, but this will require the authoritative DNS server to become highly dynamic by itself, which would be a new requirement for the server.

In the example solution, the authoritative DNS server can maintain its operation based on relatively static and coarse grained configuration as of today. The dynamic selection among all candidate EASs deployed at the edge of the mobile network is performed by the control plane functions. The new functionality can be embedded into an existing function especially the SMF or be introduced as a new function such as an INCF which operates together with the SMF. The control plane already possesses the detailed network topology and metric information, such as the delay from the UE to potential PSA-UPFs. The relevant compute metrics about the EASs' deployed at the network edge are obtained via suitable interfaces, and the EASs or compute platforms are provided by a separate provider from the network itself.

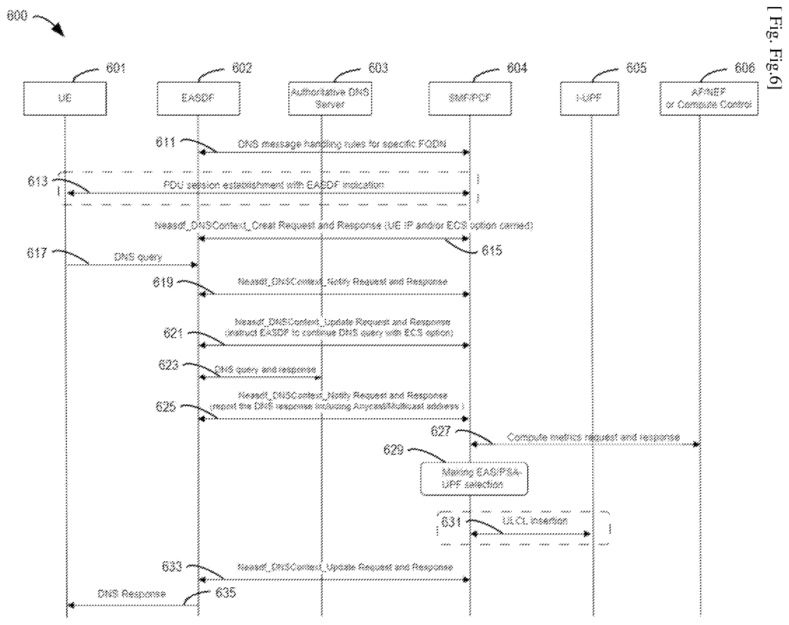

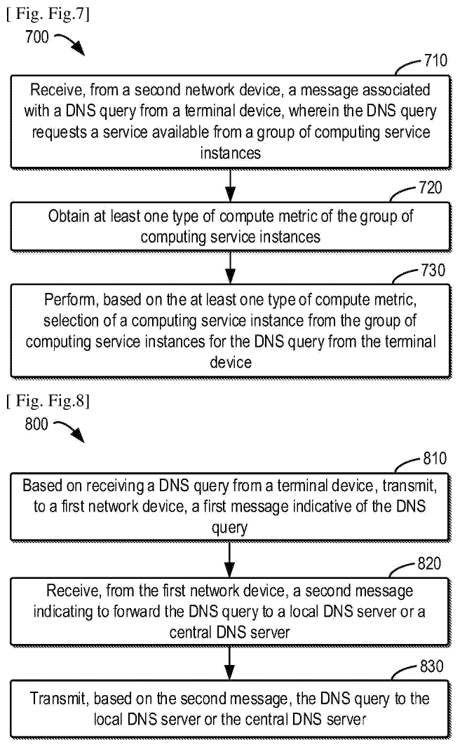

FIG. 7 shows a flowchart of an example method 700 implemented at a first network device in accordance with some embodiments of the present disclosure. For the purpose of discussion, the method 700 will be described from the perspective of the first network device 110 with reference to FIG. 1A.

At block 710, the first network device 110 receives a message from a second network device. The message is associated with a domain name system (DNS) query from a terminal device. The DNS query requests a service available from a group of computing service instances. At block 720, the first network device 110 obtain at least one type of compute metric of the group of computing service instances. At block 730, based on the at least one type of compute metric, the first network device 110 performs selection of a computing service instance from the group of computing service instances for the DNS query from the terminal device.

In some embodiments, based on the at least one type of compute metric, at least one type of network metric associated with the group of computing service instance and information of egress nodes of the network domain, the first network device 110 may perform selection of an egress node of a network domain.

In some embodiments, after performing the selection of a computing service instance from the group of computing service instances, the first network device may further transmit a first response message to the second network device, and the first response message indicates to forward the DNS query to the DNS server. The DNS server is a local DNS server or a central DNS server.

In some embodiments, in order to transmit the first response message, the first network device 110 may transmit the first response message indicating to forward the DNS query to the local DNS server based on selecting a computing service instance from the group of computing service instances. In some embodiments, in order to transmit the first response message, the first network device 110 may transmit the first response message indicating to forward the DNS query to the central DNS server based on failing to select a computing service instance from the group of computing service instances.

In some embodiments, the first network device 110 may further receive a second message from the second network device. The second DNS request message reporting the DNS response received by the second network device from a DNS server. The DNS response comprises an anycast address or a multicast address associated with the service requested by the terminal device. After that, the first network device 110 may steer traffic associated with the service of the terminal device to the egress node.

In some embodiments, the message may comprise a second message reporting that a DNS response received by the second network device from a DNS server includes a subnet option value associated with the terminal device.

In some embodiments, the first network device 110 may further receive a DNS request message reporting the DNS query to the first network device from the second network device prior to receiving the second message. After that, the first network device 110 may transmit a second response message to the second network device, and the second response message indicates to add the subnet option value into the first DNS query to obtain a second DNS query. The subnet option value is indicative of network access information, a location of the terminal device, a set of egress nodes available for the location of the terminal device, or any combination of two or more of the above-mentioned items.

In some embodiments, the message may comprise a FQDN indicating the service requested by the terminal device. In some embodiments, in order to obtain the at least one type of compute metric, the first network device 110 may receive the at least one type of compute metric based on transmitting a request for the at least one type of compute metric. In some embodiments, in order to obtain the at least one type of compute metric, the first network device 110 may receive the at least one type of compute metric based on subscribing dynamic update of the at least one type of compute metric.

In some embodiments, the at least one type of compute metric may comprise load information of the group of computing service instances. In some embodiments, the at least one type of compute metric may be indexed by an FQDN, an anycast address corresponding to the service, or a combination of the above-mentioned two items.

FIG. 8 shows a flowchart of an example method 800 implemented at a second network device in accordance with some embodiments of the present disclosure. For the purpose of discussion, the method 800 will be described from the perspective of the second network device 120 with reference to FIG. 1A.

At block 810, based on receiving a domain name system (DNS) query from a terminal device, the second network device 120 transmits a first message indicative of the DNS query to a first network device. At block 820, the second network device 120 receives a second message from the first network device. The second message indicates to forward the DNS query to a local DNS server or a central DNS server. At block 830, the second network device 120 transmits the DNS query to the local DNS server or the central DNS server based on the second message.

In some embodiments, the second message may indicate to forward the DNS query to the local DNS server, in the case that a computing service instance is selected from a group of computing service instances by the first network device. In some embodiments, the second message may indicate to forward the DNS query to the central DNS server, in the case that no computing service instance is selected from the group of computing service instances by the first network device.

In some embodiments, the second message indicates to forward the DNS query to the local DNS server, and the second network device may further receive a DNS response comprising an anycast address or a multicast address corresponding to the service requested by the DNS query from the local DNS server. Then the second network device may transmit a third message reporting that a DNS response received by the second network device from the local DNS server to the first network device. In some embodiments, the DNS query may comprise a FQDN indicating the service.

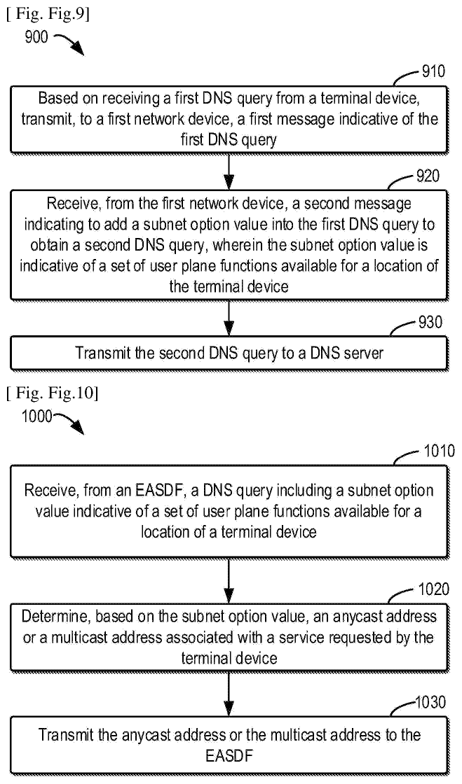

FIG. 9 shows a flowchart of an example method 900 implemented at a second network device in accordance with some embodiments of the present disclosure. For the purpose of discussion, the method 900 will be described from the perspective of the second network device 120 with reference to FIG. 1A.

At block 910, based on receiving a first domain name system (DNS) query from a terminal device, the second network device 120 transmits a first message indicative of the first DNS query to a first network device. At block 920, the second network device 120 receives a second message from the first network device, and the second message indicates to add a subnet option value into the first DNS query to obtain a second DNS query. The subnet option value is indicative of network access information or a location of the terminal device. At block 930, the second network device 120 transmits the second DNS query to a DNS server.

In some embodiments, the second network device may receive a DNS response from the DNS server. The DNS response comprises an anycast address or a multicast address corresponding to a service requested by the first DNS query. Then the second network device may transmit a third message to the first network device, the third message reports that a DNS response received by the second network device from a DNS server includes a subnet option value associated with the terminal device.

In some embodiments, the subnet option value may further indicative of a set of egress nodes of a network domain available for the location of the terminal device.

FIG. 10 shows a flowchart of an example method 1000 implemented at a domain name system (DNS) server in accordance with some embodiments of the present disclosure. For the purpose of discussion, the method 1000 will be described from the perspective of the DNS server 130 with reference to FIG. 1A.

At block 1010, the DNS server receives a DNS query from an edge application server discovery function (EASDF). The DNS query includes a subnet option value indicative of network access information or a location of a terminal device. At block 1020, based on the subnet option value, the DNS server determines an anycast address or a multicast address associated with a service requested by the terminal device. At block 1030, the DNS server transmits the anycast address or the multicast address to the EASDF.

In some embodiments, the subnet option value may further indicative of a set of egress nodes of a network domain available for the location of the terminal device.

In some embodiments, an apparatus capable of performing any of the method 700 (for example, the first network device 110) is provided. The apparatus may comprise means for performing the respective steps of the method 700. The means may be implemented in any suitable form. For example, the means may be implemented in a circuitry or software module.

In some embodiments, the apparatus comprises means for receiving, from a second network device, a message associated with a domain name system (DNS) query from a terminal device, wherein the DNS query requests a service available from a group of computing service instances; means for obtaining at least one type of compute metric of the group of computing service instances; and means for performing, based on the at least one type of compute metric, selection of a computing service instance from the group of computing service instances for the DNS query from the terminal device.

In some embodiments, the apparatus may comprise means for performing selection of an egress node of a network domain, based on the at least one type of compute metric, at least one type of network metric associated with the group of computing service instance and information of egress nodes of the network domain. In some embodiments, the message may comprise a DNS request message reporting the DNS query to the first network device.

In some embodiments, the apparatus may comprise means for after performing the selection of a computing service instance from the group of computing service instances, transmitting, to the second network device, a first response message indicating to forward the DNS query to the DNS server, wherein the DNS server is a local DNS server or a central DNS server.

In some embodiments, means for transmitting the first response message may comprise means for transmitting, based on selecting a computing service instance from the group of computing service instances, the first response message indicating to forward the DNS query to the local DNS server; and means for transmitting, based on failing to select a computing service instance from the group of computing service instances, the first response message indicating to forward the DNS query to the central DNS server.

In some embodiments, the apparatus may comprise means for receiving, from the second network device, a second message reporting the DNS response received by the second network device from a DNS server, wherein the DNS response comprises an anycast address or a multicast address associated with the service requested by the terminal device; and means for steering traffic associated with the service of the terminal device to the egress node.

In some embodiments, the message may comprise a second message reporting that a DNS response received by the second network device from a DNS server includes a subnet option value associated with the terminal device.

In some embodiments, the apparatus may further comprise means for prior to receiving the second message, receiving, from the second network device, a DNS request message reporting the DNS query to the first network device; and means for transmitting, to the second network device, a second response message indicating to add the subnet option value into the first DNS query to obtain a second DNS query, wherein the subnet option value is indicative of at least one of: network access information, a location of the terminal device, or a set of egress nodes available for the location of the terminal device.

In some embodiments, the message may comprise a FQDN indicating the service requested by the terminal device. In some embodiments, means for obtaining the at least one type of compute metric may comprise means for receiving the at least one type of compute metric based on transmitting a request for the at least one type of compute metric; or mean for receiving the at least one type of compute metric based on subscribing dynamic update of the at least one type of compute metric.

In some embodiments, the at least one type of compute metric may comprise load information of the group of computing service instances. In some embodiments, the at least one type of compute metric may be indexed by at least one of the following: an FQDN; or an anycast address corresponding to the service.

In some embodiments, the apparatus may further comprise means for performing other steps in some embodiments of the method 700. In some embodiments, the means comprises at least one processor and at least one memory including computer program code, the at least one memory and computer program code configured to, with the at least one processor, cause the performance of the apparatus.

In some embodiments, an apparatus capable of performing any of the method 800 (for example, the second network device 120) is provided. The apparatus may comprise means for performing the respective steps of the method 800. The means may be implemented in any suitable form. For example, the means may be implemented in a circuitry or software module.

In some embodiments, the apparatus comprises means for based on receiving a domain name system (DNS) query from a terminal device, transmitting, to a first network device, a first message indicative of the DNS query; means for receiving, from the first network device, a second message indicating to forward the DNS query to a local DNS server or a central DNS server; and means for transmitting, based on the second message, the DNS query to the local DNS server or the central DNS server.

In some embodiments, the second message may indicate to forward the DNS query to the local DNS server, in the case that a computing service instance is selected from a group of computing service instances by the first network device; and the second message may indicate to forward the DNS query to the central DNS server, in the case that no computing service instance is selected from the group of computing service instances by the first network device.

In some embodiments, the second message indicates to forward the DNS query to the local DNS server, wherein the apparatus may further comprise means for receiving, from the local DNS server, a DNS response comprising an anycast address or a multicast address corresponding to the service requested by the DNS query; and means for transmitting, to the first network device, a third message reporting that a DNS response received by the second network device from the local DNS server. In some embodiments, the DNS query may comprise a fully qualified domain name (FQDN) indicating the service.

In some embodiments, the apparatus may further comprise means for performing other steps in some embodiments of the method 800. In some embodiments, the means comprises at least one processor and at least one memory including computer program code, the at least one memory and computer program code configured to, with the at least one processor, cause the performance of the device.

In some embodiments, an apparatus capable of performing any of the method 900 (for example, the second network device 120) is provided. The apparatus may comprise means for performing the respective steps of the method 900. The means may be implemented in any suitable form. For example, the means may be implemented in a circuitry or software module.

In some embodiments, the apparatus comprises means for based on receiving a first domain name system (DNS) query from a terminal device, transmitting, to a first network device, a first message indicative of the first DNS query; means for receiving, from the first network device, a second message indicating to add a subnet option value into the first DNS query to obtain a second DNS query, wherein the subnet option value is indicative of network access information or a location of the terminal device; and means for transmitting the second DNS query to a DNS server.

In some embodiments, the apparatus may comprise means for receiving, from the DNS server, a DNS response comprising an anycast address or a multicast address corresponding to a service requested by the first DNS query; and means for transmitting, to the first network device, a third message reporting that a DNS response received by the second network device from a DNS server includes a subnet option value associated with the terminal device.

In some embodiments, the subnet option value may further indicative of a set of egress nodes of a network domain available for the location of the terminal device.

In some embodiments, the apparatus may further comprise means for performing other steps in some embodiments of the method 900. In some embodiments, the means comprises at least one processor and at least one memory including computer program code, the at least one memory and computer program code configured to, with the at least one processor, cause the performance of the device.

In some embodiments, an apparatus capable of performing any of the method 1000 (for example, the DNS server 130) is provided. The apparatus may comprise means for performing the respective steps of the method 1000. The means may be implemented in any suitable form. For example, the means may be implemented in a circuitry or software module.

In some embodiments, the apparatus comprises means for receiving, from an edge application server discovery function (EASDF), a DNS query including a subnet option value indicative of network access information or a location of a terminal device; means for determining, based on the subnet option value, an anycast address or a multicast address associated with a service requested by the terminal device; and means for transmitting the anycast address or the multicast address to the EASDF.

In some embodiments, the subnet option value may further indicative of a set of egress nodes of a network domain available for the location of the terminal device.

In some embodiments, the apparatus may further comprise means for performing other steps in some embodiments of the method 1000. In some embodiments, the means comprises at least one processor; and at least one memory including computer program code, the at least one memory and computer program code configured to, with the at least one processor, cause the performance of the device.

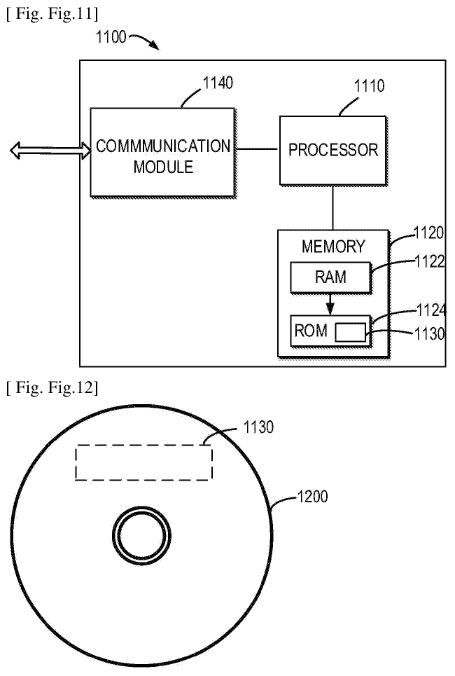

FIG. 11 is a simplified block diagram of a device 1100 that is suitable for implementing embodiments of the present disclosure. The device 1100 may be provided to implement the communication device, for example the first network device 110, the second network device 120 and a DNS server 130 as shown in FIG. 1A. As shown, the device 1100 includes one or more processors 1110, and one or more communication modules 1140 coupled to the processor 1110. The device 1100 may further include one or more memories 1120 coupled to the processor 1110.

The communication modules 1140 may be for bidirectional communications. The communication modules 1140 has at least one antenna to facilitate communication. The communication interface may represent any interface that is necessary for communication with other network elements.

The processor 1110 may be of any type suitable to the local technical network and may include one or more of the following: general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

The memory 1120 may include one or more non-volatile memories and one or more volatile memories. Examples of the non-volatile memories include, but are not limited to, a Read Only Memory (ROM) 1124, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1122 and other volatile memories that will not last in the power-down duration.

A computer program 1130 includes computer executable instructions that are executed by the associated processor 1110. The program 1130 may be stored in the ROM 1124. The processor 1110 may perform any suitable actions and processing by loading the program 1130 into the RAM 1122.

The embodiments of the present disclosure may be implemented by means of the program 1130 so that the device 1100 may perform any process of the disclosure as discussed with reference to FIGS. 2 to 10. The embodiments of the present disclosure may also be implemented by hardware or by a combination of software and hardware.

In some embodiments, the program 1130 may be tangibly contained in a computer readable medium which may be included in the device 1100 (such as in the memory 1120) or other storage devices that are accessible by the device 1100. The device 1100 may load the program 1130 from the computer readable medium to the RAM 1122 for execution. The computer readable medium may include any types of tangible non-volatile storage, such as ROM, EPROM, a flash memory, a hard disk, CD, DVD, and the like. FIG. 12 shows an example of the computer readable medium 1200 in form of CD or DVD. The computer readable medium has the program 1130 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 700, 800, 900, or 1000 as described above with reference to FIG. 7-FIG. 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/ operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory, ” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-30. (canceled)

31. A first network device comprising:
at least one processor; and
at least one memory storing instructions that, when executed by the at least one processor, cause the first network device at least to:
receive, from a second network device, a message associated with a domain name system (DNS) query from a terminal device, wherein the DNS query requests a service available from a group of computing service instances;
obtain at least one type of compute metric of the group of computing service instances; and
perform, based on the at least one type of compute metric, selection of a computing service instance from the group of computing service instances for the DNS query from the terminal device.

32. The first network device of claim 31, wherein the first network device is further caused to:
perform selection of an egress node of a network domain, based on the at least one type of compute metric, at least one type of network metric associated with the group of computing service instance and information of egress nodes of the network domain.

33. The first network device of claim 31, wherein the message comprises a DNS request message reporting the DNS query to the first network device.

34. The first network device of claim 33, wherein the first network device is further caused to:
after performing the selection of a computing service instance from the group of computing service instances, transmit, to the second network device, a first response message indicating to forward the DNS query to the DNS server, wherein the DNS server is a local DNS server or a central DNS server.

35. The first network device of claim 34, wherein the first network device is caused to transmit the first response message by:
transmitting, based on selecting a computing service instance from the group of computing service instances, the first response message indicating to forward the DNS query to the local DNS server; and
transmitting, based on failing to select a computing service instance from the group of computing service instances, the first response message indicating to forward the DNS query to the central DNS server.

36. The first network device of claim 34, wherein the first network device is further caused to:
receive, from the second network device, a second message reporting the DNS response received by the second network device from a DNS server, wherein the DNS response comprises an anycast address or a multicast address associated with the service requested by the terminal device; and
steer traffic associated with the service of the terminal device to the egress node.

37. The first network device of claim 31, wherein the message comprises a second message reporting that a DNS response received by the second network device from a DNS server includes a subnet option value associated with the terminal device.

38. The first network device of claim 37, wherein the first network device is further caused to:
prior to receiving the second message, receive, from the second network device, a DNS request message reporting the DNS query to the first network device; and
transmit, to the second network device, a second response message indicating to add the subnet option value into the first DNS query to obtain a second DNS query, wherein the subnet option value is indicative of at least one of: network access information, a location of the terminal device, or a set of egress nodes available for the location of the terminal device.

39. The first network device of claim 31, wherein the message comprises a fully qualified domain name (FQDN) indicating the service requested by the terminal device.

40. The first network device of claim 31, wherein the first network device is further caused to obtain the at least one type of compute metric by:
receiving the at least one type of compute metric based on transmitting a request for the at least one type of compute metric; or
receiving the at least one type of compute metric based on subscribing dynamic update of the at least one type of compute metric.

41. The first network device of claim 31, wherein the at least one type of compute metric comprises load information of the group of computing service instances.

42. The first network device of claim 31, wherein the at least one type of compute metric is indexed by at least one of the following:
an FQDN; or
an anycast address corresponding to the service.

43. A second network device comprising:
at least one processor; and
at least one memory storing instructions that, when executed by the at least one processor, cause the second network device at least to:
based on receiving a domain name system (DNS) query from a terminal device, transmit, to a first network device, a first message indicative of the DNS query;
receive, from the first network device, a second message indicating to forward the DNS query to a local DNS server or a central DNS server; and
transmit, based on the second message, the DNS query to the local DNS server or the central DNS server.

44. The second network device of claim 43, wherein one of:
the second message indicates to forward the DNS query to the local DNS server, in the case that a computing service instance is selected from a group of computing service instances by the first network device; and
the second message indicates to forward the DNS query to the central DNS server, in the case that no computing service instance is selected from the group of computing service instances by the first network device.

45. The second network device of claim 43, wherein the second message indicates to forward the DNS query to the local DNS server, wherein the second network device is further caused to:
receive, from the local DNS server, a DNS response comprising an anycast address or a multicast address corresponding to the service requested by the DNS query; and
transmit, to the first network device, a third message reporting that a DNS response received by the second network device from the local DNS server.

46. The second network device of claim 43, wherein the DNS query comprises a fully qualified domain name (FQDN) indicating the service.

47. A method comprising:
receiving, at a first network device from a second network device, a message associated with a domain name system (DNS) query from a terminal device, wherein the DNS query requests a service available from a group of computing service instances;
obtaining at least one type of compute metric of the group of computing service instances; and
performing, based on the at least one type of compute metric, selection of a computing service instance from the group of computing service instances for the DNS query from the terminal device.

48. The method of claim 47 further comprising:
performing selection of an egress node of a network domain, based on the at least one type of compute metric, at least one type of network metric associated with the group of computing service instance and information of egress nodes of the network domain.

49. The method of claim 47 further comprising:
after performing the selection of a computing service instance from the group of computing service instances, transmitting from the first network device to the second network device, a first response message indicating to forward the DNS query to the DNS server, wherein the DNS server is a local DNS server or a central DNS server.

50. The method of claim 49 further comprising, at the first network device:
transmitting, based on selecting a computing service instance from the group of computing service instances, the first response message indicating to forward the DNS query to the local DNS server; and
transmitting, based on failing to select a computing service instance from the group of computing service instances, the first response message indicating to forward the DNS query to the central DNS server.
